(19) United States
(12) Patent Application Publication
(10) Pub. No.: US 2012/0024299 A1
(43) Pub. Date: Feb. 2, 2012

(54) Dental thermo-forming material

(75) Inventor: Christian Scheu, Dortmund (DE)

(73) Assignee: Scheu-Dental GmbH, Iserlohn (DE)

(21) Appl. No.: 13/136,103

(22) Filed: Jul. 22, 2011

(30) Foreign Application Priority Data
Jul. 28, 2010 (DE) 20 2010 010 769.5

(51) Int. Cl. A61C 5/14; B32B 5/00

(52) U.S. Cl. 128/861; 428/53

(57) ABSTRACT

A thermo-forming foil or plate made of a thermoplastic elastomer for the production of dental splints. To integrate reinforcements for various applications into individual areas of the splint, the thermo-forming foil or plate is made of segments comprised of different materials and lying side by side in the plane of the thermo-forming foil or plate, these materials having different Shore hardness.

### CROSS REFERENCE TO RELATED APPLICATIONS

Applicant claims priority under 35 U.S.C. 119 of German Application No. 20 2010 010 769.5 filed Jul. 28, 2010.

### BACKGROUND OF THE INVENTION

The invention relates to a thermo-forming foil or plate made of a thermoplastic elastomer for the production of dental splints.

Thermoplastic plastic foils or plates have been known in thermo-forming technology for a long time.

In thermo-forming technology, a foil or plate which in most applications is comprised of thermoplastic elastomers based on EVA (ethylene vinyl acetate) is softened by heating and drawn over a model to be moulded. After cooling down, the foil or plate thus moulded is removed from the model and subjected to a further precision processing.

Among other applications, special mouthguard splints for use in sports or positioners for correction or stabilization of tooth position can be manufactured in this manner.

For certain applications, more particularly for the production of mouthguard splints, it is wished to integrate reinforcements into certain areas of a splint. A better distribution of pressure on the teeth and/or jaw can hereby be ensured, if the user is exposed to a fall or blow during sport activities or bites the teeth strongly on each other as it happens in certain types of sport or during nocturnal pressing and gnashing of teeth.

Up to now, such reinforcements are achieved by a multilayered structure of the splint. However, this always requires an additional process step which entails increased expenditure on time and cost.

Besides, special multilayered foils which contain a reinforcing layer exist in prior art. Though the production of the splint just requires one process step, the reinforcement spreads over the entire foil and thus over the entire splint, too. A merely local reinforcement of the splint in special dental areas and thus a well-aimed adapted pressure distribution cannot be achieved with these thermo-forming foils.

### SUMMARY OF THE INVENTION

Now, therefore, it is the object of the present invention to create a thermo-forming foil or plate which permits the production and local reinforcement of a dental splint simultaneously in one process step only.

This task is solved by the present invention in that the thermo-forming foil or plate is comprised of segments comprised of different materials and lying side by side in the plane of the thermo-forming foil, these materials having different Shore hardness. By way of such a thermo-forming foil or plate comprised of several segments lying side by side and having different Shore hardness, it is possible to produce a splint with differently hard areas in one thermo-forming process only. In this manner, splints individually adapted to the user and to the intended application can be produced, these splints being especially hard or soft in individual areas. The distribution of hard and soft segments in the plane of the foil or plate is freely selectable. In terms of production technique, any arbitrary distributions and hardness differences are feasible.

The present invention provides for connecting the segments by means of joining procedures, more particularly by means of high-frequency welding. High-frequency welding, in particular, represents a commonly applied joining procedure by means of which plastic materials are joined with each other. In the production of thermo-forming foils and/or plates, this procedure has already been implemented successfully for the multilayered set-up of foils.

One embodiment of the present invention provides for that the thermo-forming foil or plate is comprised of a centrally arranged stripe-shaped reinforcing segment and adjacent symmetrically arranged neutral segments. In this manner, it is feasible to produce splints that are particularly reinforced in the front tooth area. To this effect, the thermo-forming foil is so arranged over the model that the segment having the higher Shore hardness (reinforcing segment) comes to rest over the front teeth, whereas the adjacent neutral segments of the foil having a slightly less Shore hardness rest over the remaining teeth.

A particularly advantageous embodiment of the present invention provides for that the thermo-forming foil or plate is comprised of a centrally arranged V-shaped reinforcing segment and adjacent symmetrically arranged neutral segments. Owing to the V-shaped reinforcing segment, different jaw sizes can be covered with the inventive thermo-forming foil or plate, depending on in which area of the V-shape the jaw model comes to rest. Thus, the harder material of the reinforcing segment which is designed to protect the front teeth is adapted in terms of its width to the jaw size.

Another embodiment of the present invention provides for that the thermo-forming foil or plate is comprised of a centrally arranged stripe-shaped neutral segment and adjacent symmetrically arranged reinforcing segments. Such a foil can be utilized for the production of splints which are to be reinforced particularly in the occlusal plane. The neutral segment having lower hardness is moulded on the front teeth, whereas the reinforcing segments having higher Shore hardness come to rest in the area of the occlusal plane.

Apart from these two embodiments, an arbitrary number of other distributions can also be realized. In particular, it is also conceivable to utilize more than two differing materials for the thermo-forming foil or plate. By means of such a foil or plate having more than two different hardness degrees, the hardness curve can be graduated more precisely over the extension of the foil or plate and be adapted to the specific requirements of the user or intended field of application.

In addition, it may be provided for to make the segments of different hardness on the foil or plate visible to a dental technician by colouring the material. Such a multicoloured foil or plate could also be produced, if the user wishes a particularly decorative colourfulness of the splint. The colourfulness may also be designed independently of the boundaries of the individual segments.

One embodiment of the present invention provides for that the thermo-forming foil or plate is comprised of one segment plane only. In most cases, this single-layered configuration is purposive and sufficient to achieve a locally reinforced mouthguard splint.

As an alternative, the thermo-forming foil or plate may also be comprised of two or more segment planes lying in parallel to each other and one above the other. A further reinforcement of the mouthguard splint is feasible by such a multilayered set-up. Likewise, a multitude of new possibilities is obtained in order to achieve a graduation of the hardness degrees or to lay patterns, e.g. a chequered structure, over the mouthguard splint. Furthermore, one of the planes of the multilayered set-up may be comprised of several segments lying side by side, whereas another plane is comprised of a single segment.

With advantage, the thermo-forming foil or plate is so configured that the segment planes lying above each other have different degrees of Shore hardness. This is achieved by utilizing segments (1, 2) with different degrees of Shore hardness in the segment planes. For embodiments comprising one segment plane with several segments (1, 2) and one segment plane with one segment only, it is recommendable to utilize different degrees of hardness so that the plane comprising only one segment simultaneously assumes, for example, a more or less reinforcing function apart from its carrier function.

The invention furthermore provides for a set of thermo-formable elements for the production of dental splints, said set comprised of an inventive thermo-forming foil or plate as well as a mandibular arch shield and a base foil. On production of a dental splint from such a set, the mandibular arch shield is arranged in parallel to and between the base foil as well as the thermo-forming foil or plate. The mandibular arch shield serves as an additional reinforcing element made of hard plastics which is connected with the thermo-forming foil or plate. The dental splint is manufactured by a dental technician in the way that a mandibular arch shield matching the jaw size and already having the shape of the jaw is laid on the thermo-forming foil or plate. Subsequently, for connection with the thermo-forming foil or plate, a base foil is laid onto the mandibular arch shield so that the mandibular arch shield comes to rest between the thermo-forming foil or plate and the base foil. After thermo-forming of the elements arranged in this manner, the mandibular arch shield lies so over the user's teeth that blows or knocks (e.g. in sport activities) are evenly distributed to the teeth. The produced dental splint in total is comprised of a 4-layered composite which from outside to inside is comprised of the 2-layered thermo-forming foil or plate, the mandibular arch shield and the base foil.

### BRIEF DESCRIPTION OF THE DRAWINGS

Practical examples of the invention are elucidated more precisely in the following by taking reference to the figures, wherein:

FIG. 1: shows a top view on an inventive thermo-forming foil or plate with a stripe-shaped reinforcing segment,

FIG. 2: shows a top view on an inventive thermo-forming foil or plate with a V-shaped reinforcing segment,

FIG. 3: shows a sectional view of a thermo-forming foil composite made of a set of thermo-formable elements.

### DETAILED DESCRIPTION OF THE EMBODIMENTS

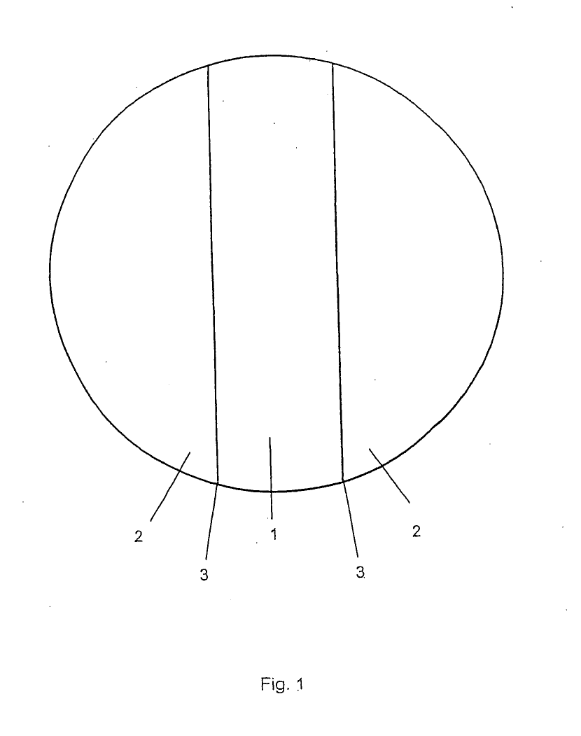

FIG. 1 illustrates a thermo-forming foil which is comprised of a centrally arranged stripe-shaped reinforcing segment 1 and two adjacent symmetrically arranged neutral segments 2. The reinforcing segment 1 is separated by welding seams 3 from the neutral segments 2.

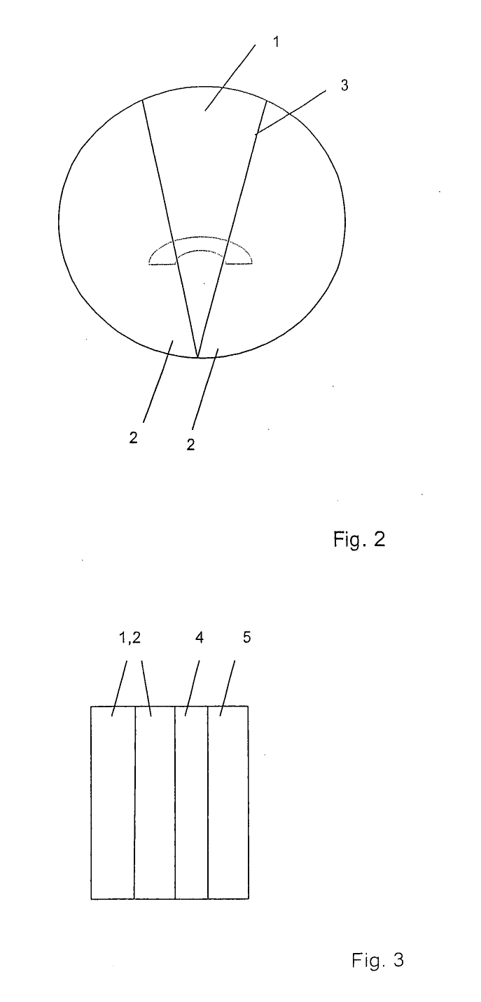

FIG. 2 shows a thermo-forming foil with a V-shaped reinforcing segment 1 and two adjacent symmetrically arranged neutral segments 2. Arranged under this segment plane is a—not shown—second segment plane which comprises one segment only. This second segment plane is comprised of a material softer than the segments of the first plane.

The composite according to FIG. 3 in a lateral view shows four planes comprised of thermo-formable material. The outside of the subsequent dental splint is formed by the left side of the foil composite, whereas the inside of the splint is formed by the right side of the foil composite. Viewed from outside to the inside, the thermo-forming foil composite is comprised of the thermo-forming foil or plate 1, 2 which is two-layered, as well as of a mandibular arch shield 4 and a base foil 5.

The thermo-forming foils as per FIGS. 1 and 2 are utilized for the production of mouthguard splints in which it is especially intended to protect the front teeth by a reinforcement of the splint in this area.

For the inventive thermo-forming foils, a stripe-shaped (FIG. 1) or V-shaped (FIG. 2) reinforcing segment 1 and two adjacent symmetrically arranged neutral segments 2 comprised of thermoplastic elastomers having different Shore hardness are laid side by side and joined with each other by means of high-frequency welding.

The foil produced in this manner is then laid by a dental technician over a tooth model, arranging the reinforcing segment 1 and the two neutral segments 2 over the model so that the reinforcing segment 1 having the higher Shore hardness rests over the front teeth, whereas the neutral segments 2 come to rest over the other teeth. In case of a thermo-forming foil according to FIG. 2, a dental technician will choose an extract of the V-shaped area that matches the jaw size.

The further thermo-forming process is realized in the same manner as done with common thermo-forming foils utilized in prior art. Further process steps for reinforcing the splint are not required.

The thermo-forming foil composite according to FIG. 3 is utilized for the production of especially strained and stressed dental splints, more particularly for the protection of a user active in sports and exposed to heightened risks, e.g. ice hockey. For the production of the composite, a thermo-forming foil or plate according to FIG. 1 or 2 (or variants deviating thereof) is utilized. A mandibular arch shield 4 of a matching size is subsequently laid onto the thermo-forming foil or plate in suitable extent of the stripe-shaped or V-shaped reinforcing segment 1 and covered with a base foil 5. Afterwards, the layers are joined with each other by applying the thermo-forming technique. To this effect, the stack of foils is laid over a tooth model as usual, with the base foil 5 pointing into the direction of the tooth model. Furthermore, the composite is so aligned that the mandibular arch shield 4 lies exactly over the arch of the jaw model. The further thermo-forming process here, too, is realized in the same manner as done with common thermo-forming foils utilized in prior art.

What is claimed is:

1. A thermo-forming foil or plate made of a thermoplastic elastomer for the production of dental splints, wherein the thermo-forming foil or plate in a plane of the thermo-forming foil or plate is comprised of segments lying side by side and made of different materials from each other, the materials having different Shore hardnesses from each other.

2. The thermo-forming foil or plate according to claim 1, wherein the segments are connected with each other by high-frequency welding.

3. The thermo-forming foil or plate according to claim 1, wherein the segments comprise a centrally arranged stripe-shaped reinforcing segment and adjacent symmetrically arranged neutral segments.

4. The thermo-forming foil or plate according to claim 1, wherein the segments comprise a centrally arranged V-shaped reinforcing segment and adjacent symmetrically arranged neutral segments.

5. The thermo-forming foil or plate according to claim 1, wherein the segments comprise a centrally arranged neutral segment and adjacent symmetrically arranged reinforcing segments.

6. The thermo-forming foil or plate according to claim 1, wherein the segments are made of more than two different materials.

7. The thermo-forming foil or plate according to claim 1, wherein the thermo-forming foil or plate is comprised of only one segment plane.

8. The thermo-forming foil or plate according to claim 1, wherein the thermo-forming foil or plate is comprised of two or more segment planes lying parallel to and one on top of the other.

9. The thermo-forming foil or plate according to claim 8, wherein adjacent segment planes have different Shore hardnesses.

10. A set of thermo-formable elements for the production of dental splints, comprising:
a thermo-forming foil or plate made of a thermoplastic elastomer for the production of dental splints, wherein the thermo-forming foil or plate in a plane of the thermo-forming foil or plate is comprised of segments lying side by side and made of different materials from each other, the materials having different Shore hardnesses from each other,
a mandibular arch shield; and
a base foil.

11. A mouthguard splint, produced from a thermo-forming foil or plate made of a thermoplastic elastomer for the production of dental splints, wherein the thermo-forming foil or plate in a plane of the thermo-forming foil or plate is comprised of segments lying side by side and made of different materials from each other, the materials having different Shore hardnesses from each other.

12. A mouthguard splint, produced from a thermo-forming foil composite comprising:
a thermo-forming foil or plate made of a thermoplastic elastomer for the production of dental splints, wherein the thermo-forming foil or plate in a plane of the thermo-forming foil or plate is comprised of segments lying side by side and made of different materials from each other, the materials having different Shore hardnesses from each other;
a mandibular arch shield; and
a base foil.
